(19) United States
(12) Patent Application Publication
(10) Pub. No.: US 2015/0357928 A1
(43) Pub. Date: Dec. 10, 2015

(54) DC POWER SUPPLY DEVICE

(71) Applicant: SANYO ELECTRIC CO., LTD, Osaka (JP)

(72) Inventor: YOSHIKAZU ITAKURA, Osaka (JP)

(21) Appl. No.: 14/760,491

(22) PCT Filed: Sep. 10, 2014
(86) PCT No.: PCT/JP2014/004640

§ 371 Date: Jul. 13, 2015

(30) Foreign Application Priority Data
Nov. 21, 2013 (JP) 2013-240515

(51) Int. Cl. H02M 7/04; H02J 7/00

(52) U.S. Cl. CPC H02M 7/04; H02J 7/0068

(57) ABSTRACT

A direct current power source portion for converting inputted alternating current power to direct current power of a predetermined voltage, a plus terminal and a minus terminal connected to the direct current power source and outputting the direct current power, a communication portion for detecting a first input voltage value preset in an electric device, a controlling portion for setting voltage of the direct current power outputted from the direct current power source portion at the first input voltage value inputted from the communication portion, and a remaining voltage processing portion having a capacitor connected in parallel between the plus terminal and the minus terminal and smoothing the direct current power, the remaining voltage processing portion discharging electric charge stored in the capacitor based on the first input voltage value.

### TECHNICAL FIELD

The present invention is related to a direct current power supply device which can change an output voltage of direct current power depending on an electric device, especially, can control discharging electric charge stored in a capacitor smoothing the direct current power based on input voltage values of the electric device.

### BACKGROUND ART

A conventional direct current power supply device supplies direct current power to an electric device through a USB connector or the like. As described in patent literature 1, this conventional direct current power supply device supplies the direct current power of a constant voltage (5 V)/a constant current (for example, 1.5 A). In this direct current power supply device, output from a cylindrical battery is converted to 5 V by a DC/DC converter, and the stable direct current power is outputted.

### CITATION LIST

### Patent Literature

Patent Literature 1: Japanese Laid-Open Patent Publication No. 2009-131089

### SUMMARY OF THE INVENTION

As the conventional direct current power supply device supplies the direct current power of the constant voltage (5 V)/the constant current (1.5 A), in a case where the secondary battery incorporated in the electric device has a large capacity, there is a problem that charging time is long. When charging current is increased twice or three times more than the constant current (1.5 A), there is a possibility that a charging cable might be degraded. Recently, in the electric device having the secondary battery of the large capacity, a predetermined input voltage is increased to 9 V or 12 V from 5 V, and then the technology that this enables a quick charging is being developed. But, when the electric device having the input voltage value of 9 V or 12 V is charged by the direct current power supply device of 5 V, as supplying power per unit time is small because of the small charging voltage of 5V, it is impossible to supply adequate power to the electric device in a short time. To resolve this problem, it is desirable that also the direct current power supply device increases the voltage of the direct current power. Further, in order that it can charge any one of the electric devices having the predetermined input voltage value of 5V, 9V, or 12V, it is desirable that the direct current power supply device can change the voltage of the direct current power in accordance with the electric devices.

However, in a case where the direct current power supply device can change the voltage of the direct current power, when the direct current power supply device in a high voltage outputting state right after the electric device is detached is connected to another electric device having the input voltage value of low or minimum voltage, a remaining energy (a remaining electric charge) stored in a capacitor smoothing the direct current power may be higher than the input voltage value of the another electric device. In such a state, when the direct current power supply device is connected to the another electric device having the lower input voltage value, as the higher voltage than the input voltage value of the another electric device is inputted in the another electric device, it may be damaged or broken.

One non-limiting and explanatory embodiment provides a direct current power supply device which can change a voltage of direct current power in accordance with an electric devices, further can solve problems arising in a case when the voltage of the direct current power is made changeable.

A direct current power supply device of the present disclosure comprises a direct current power source portion for converting inputted alternating current power to direct current power of a predetermined voltage, a plus terminal and a minus terminal connected to the direct current power source portion and outputting the direct current power, a communication portion for detecting a first input voltage value preset in an electric device, a controlling portion for setting voltage of the direct current power outputted from the direct current power source portion at the first input voltage value inputted from the communication portion, and a remaining voltage processing portion having a capacitor connected in parallel between the plus terminal and the minus terminal and smoothing the direct current power, the remaining voltage processing portion discharging electric charge stored in the capacitor based on the first input voltage value.

By the above configuration, as the output voltage is in accordance with the input voltage value set in the electric device, it can be prevented that the electric device is electrically damaged, broken by the over-voltage.

In the direct current power supply device of the present disclosure, in a case where the electric device is detached from the plus terminal and the minus terminal, and another electric device is attached, the communication portion receives a second input voltage value predetermined in the another electric device, and the controlling portion changes the voltage of the direct current power to the second input voltage value, and the remaining voltage processing portion discharges the electric charge stored in the capacitor based on a subtraction value left by subtracting the second input voltage value from the first input voltage value.

By the above configuration, even though the direct current power supply device is connected to another electric device right after the electric device is detached, it can be prevented that the connected another electric device is electrically damaged or broken.

In the direct current power supply device of the present disclosure, in a case where the subtraction value is positive, the remaining voltage processing portion discharges the electric charge stored in the capacitor.

By the above configuration, even though the predetermined input voltage of the electric device is lower than that of the another electric device, it can be prevented that the connected another electric device is electrically damaged or broken.

In the direct current power supply device of the present disclosure, in a case where the subtraction value is negative, the remaining voltage processing portion does not discharge the electric charge stored in the capacitor.

By the above configuration, when the predetermined input voltage of the electric device is higher than that of the another electric device, as the voltage of the capacitor is lower than the predetermined input voltage of the another electric device, it can be prevented that the connected another electric device is electrically damaged, broken. Further, the electric charge stored in the capacitor is used for smoothing the direct current power to the another electric device.

In the direct current power supply device of the present disclosure, in a case where the first input voltage value or the second input voltage value is a minimum voltage, the remaining voltage processing portion discharges the electric charge stored in the capacitor.

By the above configuration, regardless of the input voltage set in the electric device connected just before detaching, the electric charge is quickly discharged, and it can be prevented that the connected electric device is electrically damaged or broken.

In the direct current power supply device of the present disclosure, in a case where the communication portion cannot communicate with the another electric device, the communication portion detects the second input voltage value as the minimum value.

By the above configuration, even though communication trouble occurs, the direct current power can be supplied to the electric device, and it can be prevented that the connected electric device is electrically damaged or broken.

In the direct current power supply device of the present disclosure, the remaining voltage processing portion has a series circuit of a switching portion and a resistor, and the series circuit is connected in parallel with the capacitor, and the electric charge stored in the capacitor is discharged through the resistor by turning on the switching portion.

By the above configuration, the electric charge stored in the capacitor is quickly discharged, and it can be prevented that the connected electric device is electrically damaged or broken.

In the direct current power supply device of the present disclosure, the communication portion outputs the first input voltage value and the second input voltage value as combinations of high voltage and low voltage in two of voltage lines connected to the remaining voltage processing portion, and the switching portion becomes ON/OFF state based on the combinations.

By the above configuration, the communication portion can communicate with the remaining voltage processing portion by the simple circuit, and it can be prevented that the connected electric device is electrically damaged or broken.

The direct current power supply device of the present disclosure further comprises a secondary battery, a charging circuit for charging the secondary battery by the direct current power of the direct current power source portion, and a DC/DC converting circuit for voltage-converting direct current power from the secondary battery, and when the output power of the secondary battery is outputted to the electric device, the DC/DC converting circuit converts the voltage of the direct current power from the secondary battery to the first input voltage value which is set in the electric device and inputted from the communication portion.

By the above configuration, even in the power supply from the secondary battery, as the output voltage is in accordance with the input voltage value set in the electric device, it can be prevented that the electric device is electrically damaged, broken by the over-voltage.

In the present disclosure, the remaining voltage processing portion has the capacitor connected in parallel between the terminals and smoothing the direct current power, and the remaining voltage processing portion discharges the electric charge stored in the capacitor. The output voltage is in accordance with the electric device, and is changed from high voltage to low voltage, or to the minimum voltage. Therefore, it can be prevented that the electric device is electrically damaged, broken by the over-voltage. By this, the direct current power supply device can change the voltage of the direct current power in accordance with the electric device, and further can solve problems arising in a case when the voltage of the direct current power is made changeable.

### BRIEF DESCRIPTION OF DRAWINGS

FIG. 1 is a circuit block diagram showing a direct current power supply device of one embodiment of the present invention.

FIG. 2 is a circuit diagram showing a remaining voltage processing circuit 19 in the direct current power supply device of the one embodiment of the present invention.

FIG. 3 is a circuit diagram showing a direct current power supply device of another embodiment of the present invention.

### DESCRIPTION OF EMBODIMENTS

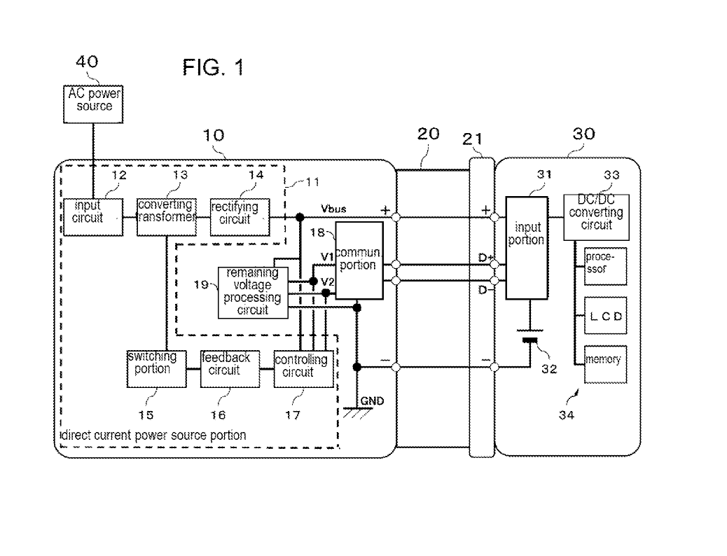

Embodiments of the present invention are explained in detail using figures. FIG. 1 is a circuit block diagram showing a direct current power supply device of one embodiment of the present invention. FIG. 1 shows electric device 30 such as a smart phone, a mobile phone, or a game device, and a direct current power supply device 10 for supplying power to electric device 30 such as an AC adapter which converts alternating current commercial power to direct current power. The direct current power supply device 10 may be a battery pack where an incorporated battery supplies the direct current power.

### (Direct Current Power Supply Device 10)

Direct current power supply device 10 has a direct current power source portion 11 which inputs commercial alternating current power from AC power source 40 and converts it to direct current power having plural voltages. Direct current power source portion 11 supplies direct current power to electric device 30 from plus terminal + and minus terminal GND through electric cable 20.

Direct current power source portion 11 has input circuit 12 which inputs the commercial alternating current power from AC power source 40. Input circuit 12 has an input filter which eliminates noise included in the commercial power source of AC 100 V, and a rectifying circuit which converts inputted alternating current to direct current.

Direct current power source portion 11 has converting transformer 13 which converts the alternating current from input circuit 12 to a predetermined voltage, rectifying circuit 14 which rectifies and converts alternating current output to direct current. Rectifying circuit 14 includes an output filter which eliminates noise. Further, direct current power source portion 11 has switching portion 15 which converts direct current from the rectifying circuit of input circuit 12 to alternating current of high-frequency, and feedback circuit 16 which controls direct current output by PWM-controlling a switching element of switching portion 15.

Further, direct current power source portion 11 has controlling circuit 17 on the secondary side which detects output voltage from rectifying circuit 14 and an input voltage value predetermined in electric device 30 based on input signal from communication portion 18 of an interface circuit to electric device 30, and controls output voltage. Controlling circuit 17 outputs controlling signal for controlling feedback circuit 16 from detection result of the output voltage of rectifying circuit 14 and the input voltage value of electric device 30. Direct current power source portion 11 sets the output voltage of the direct current power at the input voltage value set in electric device 30 based on the controlling signal of controlling circuit 17.

### (Electric Cable 20)

Electric cable 20 has connector 21 connected to electric device 30 such as a USB connector. Connector 21 has a plus input terminal+ and a minus input terminal −, and a communication terminal D+ and a communication terminal D1 which communicate with communication portion 18.

### (Electric Device 30)

Electric device 30 has input portion 31 which is connected to each of terminals in connector 21. Input portion 31 includes a charging circuit for controlling charge of secondary battery 32, or a switching circuit for switching supply of input power to secondary battery 32 or load 34. Load 34 includes a micro-processor for controlling electric device 30, a liquid crystal display (LCD), a memory, or the like. Power is supplied to load 34 through DC/DC converting circuit 33.

Input portion 31 has a charge controlling function. Secondary battery 32 of a lithium ion battery is charged with a constant current and a constant voltage which is restricted within about 4.2 V as the maximum charging voltage. Then, input portion 31 controls input voltage at 4.2 V or less as a charging voltage of secondary battery 32. Input portion 31 can increase charge current to maintain the input power by a ratio where the input voltage value (5V, 9V, 12V) is reduced to 4.2 V or less. Therefore, when the input voltage value is 9 V or 12 V, the voltage is reduced, compared with the input voltage value of 5 V, and current value can be increased by that ratio, and then charging is quickly done.

Further, input portion 31 has a communication circuit for transmitting signal to the communication terminal D+, the communication terminal D−. The communication circuit of input portion 31 transmits signal corresponding to the input voltage value set in electric device 30.

(Communication from Electric Device 30 to Direct Current Power Supply Device 10)

Direct current power supply device 10 inputs the signal of the input voltage value of electric device 30 into communication portion 18 from the communication terminal D+ and the communication terminal D−. For example, in a case where the input voltage value set in electric device 30 is any one of 5 V, 9V, or, 12 V, communication portion 18 detects any one of 5 V, 9 V, 12 V in the input voltage value set in electric device 30, and outputs voltage outputs corresponding to table 1 to two of the voltage lines at communication voltage V1, V2.

TABLE 1

| input voltage value | commun. | commun. |
|---|---|---|
| of electric device | voltage V1 | voltage V2 |
| 5 V | high voltage | high voltage |
| 9 V | low voltage | high voltage |
| 12 V | high voltage | low voltage |

Here, in a case where electric device 30 has no communication circuit in input portion 31 or the communication circuit of the electric device is broke down, as communication portion 18 cannot be communicated, communication portion 18 detects the input voltage value of electric device 30 as the minimum voltage of 5 V. Then, communication portion 18 outputs communication voltage V1, V2 to the voltage lines according to communication voltage V1, V2 shown in table 1 (V1=high voltage, V2=high voltage). In addition, the method where the input voltage value set in electric device 30 is transmitted, detected to direct current power supply device 10, and the method where communication portion 18 communicates with controlling circuit 17, are not limited to the method described in the embodiments, and can use various methods.

Communication portion 18 is connected to controlling circuit 17 and remaining voltage processing circuit 19 described below in detail by two of the voltage lines, and outputs communication voltage V1, V2.

Controlling circuit 17 detects communication voltage V1, V2 from communication portion 18, and distinguish any one of 5 V, 9V, and 12 V in the input voltage value set in electric device 30, and controls feedback circuit 16 such that the voltage of the direct current power from rectifying circuit 14 coincides with the distinguished input voltage value.

Direct current power supply device 10 of this embodiment having the above configuration, can be connected to a variety of the electric devices 30 having any one of 5 V, 9 V, and 12 V as the input voltage value, and can provide the direct current power suitable for the input voltage value of the electric device.

Here, in a case where electric device 30 connected to plus terminal + and the minus terminal − is detached from direct current power supply 10 which outputs a first input voltage value (9 V or 12 V), direct current power supply 10 may maintain a high output voltage by a remaining electric charge in smoothing capacitor C1 described below in detail. The following situation may occur. Right after electric device 30 is detached from direct current power supply 10 in a state where it outputs a first input voltage value (9 V or 12 V), another electric device 30 where the input voltage value is set at a second input voltage value (5 V) is connected to direct current power supply 10. Then, the voltage of the remaining energy (remaining electric charge) of capacitor C1 exceeds the second input voltage value (5 V), and such a voltage is outputted to another electric device 30, and another electric device 30 may be damaged or broken by an input of the overvoltage.

### (Remaining Voltage Processing Circuit 19)

In this embodiment, direct current power supply device 10 has remaining voltage processing circuit 19 which includes capacitor C1 connected in parallel between plus terminal + and minus terminal GND and smoothing the direct current power. Remaining voltage processing circuit 19 is connected to two of the voltage lines from communication portion 18, and inputs communication voltage V1, V2. When controlling circuit 17 decreases the output voltage from direct current power source portion 11 based on the communication result, or sets the minimum voltage of it, remaining voltage processing circuit 19 discharges the electric charge stored in capacitor C1.

In other words, when electric device 30 set at the first input voltage value is detached from direct current power supply device 10 and another electric device 30 set at the second input voltage value is attached, in a case where the subtraction value left by subtracting the second input voltage value from the first input voltage value is positive, or the first input voltage value or the second input voltage value is the minimum voltage (5 V), remaining voltage processing portion 19 discharges the electric charge stored in capacitor C1. On the contrary, in a case where the subtraction value left by subtracting the second input voltage value from the first input voltage value is negative, remaining voltage processing portion 19 does not discharge the electric charge stored in capacitor C1.

As shown in FIG. 1, in remaining voltage processing portion 19, a plus side line is connected to output voltage Vbus of the line of plus terminal +, and a minus side line is connected to the line of minus terminal GND of direct current power supply device 10.

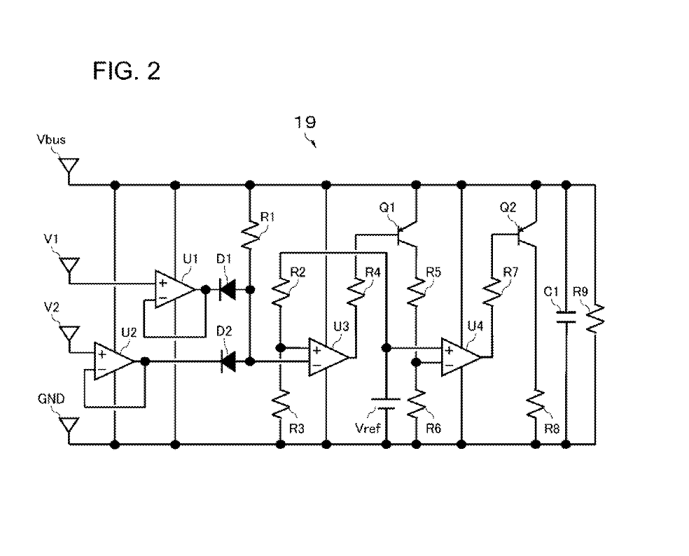

Next, a circuit configuration of remaining voltage processing circuit 19 is shown in FIG. 2. In remaining voltage processing circuit 19, capacitor C1 (1000 to 2000 μF) and resistor R9 (1 kΩ), and resistor R8 (50 to 200Ω, bleeder resistance) are connected in parallel between plus terminal + and minus terminal GND. Capacitor C1 smooths the direct current power outputted from rectifying circuit 14, and the electric charge from capacitor C1 is discharged through resistor R8. Resistor R9 is disposed to stabilize the output of the current of the direct current, but as the resistance value of resistor R9 is five times more than that of resistor R8, discharge current through resistor 9 does not flow quickly like resistor R8. Thus, resistor R9 does not play a role of the bleeder resistance. Further, even in a case where resistor R9 is not disposed, resistor R8 has the same effect of the bleeder resistance.

Communication voltage V1 from communication portion 18 is inputted in the plus side of comparator U1, and the output of comparator U1 is connected to diode D1 connected in the reverse direction. Communication voltage V2 from communication portion 18 is inputted in the plus side of comparator U2, and the output of comparator U2 is connected to diode D2 connected in the reverse direction. Diode D1 and diode D2 are connected, and connected to the line of output voltage Vbus through the minus side of comparator U3 and resistor R1 (100 kΩ).

By the connection of diode D1 and diode D2, only in the case where the outputs of both comparators U1, U2 are high voltages, namely, when both communication voltages V1, V2 are high voltages, the input of comparator U3 is lower than the reference voltage (the divided voltage of resistor R2 (5 kΩ) and resistor R3 (3 kΩ)), and the output voltage of comparator U3 becomes low voltage. The output line of comparator U3 is connected to the base of pnp type transistor Q1, and transistor Q1 becomes the ON state by applying the low voltage to the base. A series connecting line of this transistor Q1, resistor R5 (3 kΩ), and resistor R6 (2.5 kΩ) is connected between the line of plus terminal + of the direct current power supply device 10 and the line of minus terminal GND of the direct current power supply device 10.

Then, the divided voltage of output voltage Vbus of the direct current power supply device 10, is inputted in the minus side of comparator U4, and is compared with reference voltage Vref (=2.5 V). When output voltage Vbus is 6 V or more, low voltage is outputted from comparator U4. The output line of comparator U4 is connected to the base of pnp type transistor Q2 through resistor R7 (1 kΩ). Transistor Q2 is connected in series with resistor R8, and this series circuit is connected in parallel with capacitor C1.

Then, transistor Q2 becomes the ON state by applying the low voltage to the base, and the electric charge stored in capacitor C1 is discharged through resistor R8. Namely, the ON/OFF control of transistor Q2 is carried out based on the combinations of communication voltages V1, V2 inputted from the two of the voltage lines. The ON/OFF control of transistor Q2 plays a role as a switching portion of the ON/OFF control of the discharge of the electric charge in capacitor C1.

Then, when output voltage Vbus of direct current power supply device 10 becomes less than 6 V, the minus input of comparator U4 becomes less than reference voltage Vref, and the output of comparator U4 becomes high voltage, and then transistor Q2 becomes the OFF state to stop the discharge of the electric charge stored in capacitor C1.

Therefore, right after electric device 30 corresponding to the first input voltage (9 V or 12 V) is detached from direct current power supply device 10, capacitor C1 of direct current power supply device 10 has a voltage near to the first input voltage (9 V or 12 V). When immediately direct current power supply device 10 is connected to another electric device 30 corresponding to the second input voltage value (5 V), communication portion 18 detects the input voltage value as the second input voltage value (5 V), and outputs high voltages in both communication voltages V1, V2 to the two of the voltage lines. Here, the high voltages in both communication voltages V1, V2 corresponds to the second input voltage value (5 V) in electric device 30. Then, the electric charge stored in capacitor C1 is discharged in remaining voltage processing circuit 19. As this discharge decreases output voltage Vbus to low voltage, electric device 30 corresponding to the second input voltage (5 V) is not damaged by the over-voltage.

Further, there is a case where the input voltage value set in electric device 30 is increased. For example, electric device 30 is detached from direct current power supply device 10 with the first input voltage value (5 V or 9 V), and right after detaching, another electric device 30 corresponding to the second input voltage value (9 V or 12 V) is attached to direct current power supply device 10. In this case, any one of communication voltages V1, V2 of the voltage lines is low voltage as described in table 1. Then, the minus input side of comparator U3 becomes low voltage, and the output of comparator U3 becomes high voltage, and then transistor Q1 becomes the OFF state. Then, the output of comparator U4 becomes high voltage, and transistor Q2 becomes the OFF state. Namely, the electric charge stored in capacitor C1 is not discharged, and remains in capacitor C1.

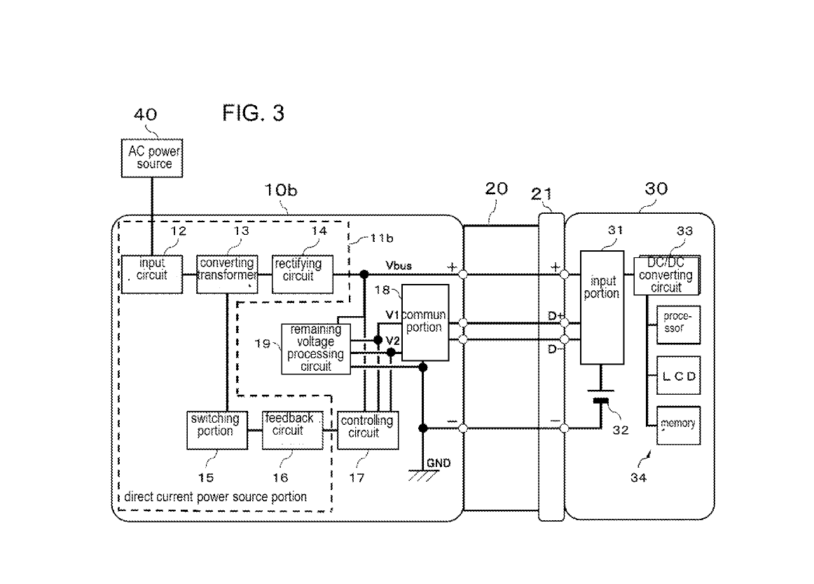

Here, in the embodiment, as shown in FIG. 1, in direct current power supply device 10, controlling circuit 17 is disposed inside direct current power source portion 11. Instead, as shown in FIG. 3, direct current power supply device 10b may comprise controlling circuit 17, and direct current power source portion 11b without the controlling circuit.

Here, in this embodiment, the direct current power supply device 10 does not incorporate the secondary battery. But, direct current power supply device 10 may comprise an incorporated secondary battery, a charging circuit which charges the secondary battery by the direct current power of direct current power source portion 11, and a DC/DC converting circuit which voltage-converts the direct current power from the secondary battery. When direct current power supply device 10 supplies the output power of the incorporated secondary battery to electric device 30, the DC/DC converting circuit provided in direct current power supply device 10, converts the voltage of the direct current power from the incorporated secondary battery to the input voltage value set in the electric device and inputted from the communication portion to output to the electric device.

Here, in this embodiment, direct current power supply device 10 is connected to electric device 30 through electric cable 20, and outputs the output power, and inputs the input voltage value set in the electric device. But, direct current power supply device 10 may output or input by non-contact method. In such a case, direct current power supply device 10 includes a power transmitting coil, and electric device 30 includes a power receiving coil for receiving the output power of the direct current power supply device 10. A communication between communication portion 18 and input portion 31 is carried out by wireless communication.

### INDUSTRIAL APPLICABILITY

The direct current power supply device of the present invention can solve problems arising in a case when the voltage of the direct current power is made changeable, and is useful as the direct current power supply device which can change the voltage of the direct current power in accordance with the electric devices.

### REFERENCE MARKS IN THE DRAWINGS

10, 10b: direct current power supply device
11, 11b: direct current power source portion
12: input circuit
13: converting transformer
14: rectifying circuit
15: switching portion
16: feedback circuit
17: controlling circuit
18: communication portion
19: remaining voltage processing circuit
+: plus terminal
GND: minus terminal
C1: capacitor
R1 to R9: resistor
U1 to U4: comparator
D1, D2: diode
Q1, Q2: transistor
Vbus: output voltage
Vref: reference voltage
V1, V2: communication voltage
20: electric cable
21: connector
+: plus input terminal
−: minus input terminal
D+, D−: communication terminal
30: electric device
31: input portion
32: secondary battery
33: DC/DC converting circuit
34: load
40: AC power source

1. A direct current power supply device comprising:
a direct current power source portion for converting inputted alternating current power to direct current power of a predetermined voltage;
a plus terminal and a minus terminal connected to the direct current power source portion and outputting the direct current power;
a communication portion for detecting a first input voltage value preset in an electric device;
a controlling portion for setting voltage of the direct current power outputted from the direct current power source portion at the first input voltage value inputted from the communication portion; and
a remaining voltage processing portion having a capacitor connected in parallel between the plus terminal and the minus terminal and smoothing the direct current power, the remaining voltage processing portion discharging electric charge stored in the capacitor based on the first input voltage value,
wherein in a case where the electric device is detached from the plus terminal and the minus terminal, and another electric device is attached,
the communication portion receives a second input voltage value preset in the another electric device,
the controlling portion changes the voltage of the direct current power to the second input voltage value, and
the remaining voltage processing portion discharges the electric charge stored in the capacitor based on a subtraction value left by subtracting the second input voltage value from the first input voltage value,
wherein in a case where the communication portion cannot communicate with the another electric device,
the communication portion detects the second input voltage value as a minimum value.

2. (canceled)

3. The direct current power supply device according to claim 1,
wherein in a case where the subtraction value is positive,
the remaining voltage processing portion discharges the electric charge stored in the capacitor.

4. The direct current power supply device according to claim 1,
wherein in a case where the subtraction value is negative,
the remaining voltage processing portion does not discharge the electric charge stored in the capacitor.

5. The direct current power supply device according to claim 1,
wherein in a case where the first input voltage value or the second input voltage value is a minimum voltage,
the remaining voltage processing portion discharges the electric charge stored in the capacitor.

6. (canceled)

7. The direct current power supply device according to claim 1,
wherein the remaining voltage processing portion has a series circuit formed of a switching portion and a resistor, and the series circuit is connected in parallel with the capacitor,
the electric charge stored in the capacitor is discharged to the resistor by turning on the switching portion.

8. The direct current power supply device according to claim 7,
wherein the communication portion outputs the first input voltage value and the second input voltage value as combinations of high voltage and low voltage in two voltage lines connected to the remaining voltage processing portion, and
the switching portion becomes ON/OFF state based on the combinations.

9. The direct current power supply device according to claim 1,
further comprising:
a secondary battery;
a charging circuit for charging the secondary battery with the direct current power supplied from the direct current power source portion; and
a DC/DC converting circuit for voltage-converting a direct current power supplied from the secondary battery,
wherein when the output power of the secondary battery is outputted to the electric device, the DC/DC converting circuit converts the voltage of the direct current power from the secondary battery to the first input voltage value which is set in the electric device and supplied from the communication portion.
